(19) United States
(12) Patent Application Publication
(10) Pub. No.: US 2025/0314025 A1
(43) Pub. Date: Oct. 9, 2025

(54) POTHOLE PREDICTION SYSTEM, POTHOLE PREDICTION METHOD, AND RECORDING MEDIUM

(71) Applicant: NEC Corporation, Minato-ku, Tokyo (JP)

(72) Inventors: Yusuke MIZUKOSHI, Tokyo (JP); Chisato SUGAWARA, Tokyo (JP); Yosuke KIMURA, Tokyo (JP); Toshimichi YOKOTE, Tokyo (JP)

(73) Assignee: NEC Corporation, Minato-ku, Tokyo (JP)

(21) Appl. No.: 18/865,775

(22) PCT Filed: Jun. 13, 2022
(86) PCT No.: PCT/JP2022/023611

§ 371 Date: Nov. 14, 2024

(51) Int. Cl. E01C 23/01; G01N 21/88; G01N 21/95; G06T 7/00; G06V 10/774; G06V 20/56

(52) U.S. Cl. CPC E01C 23/01; G01N 21/8851; G01N 21/95; G06T 7/0002; G06V 10/774; G06V 20/588; G06T 2207/20021; G06T 2207/20076; G06T 2207/20081; G06T 2207/30252

(57) ABSTRACT

A pothole prediction system according to an aspect of the present disclosure includes: at least one memory storing instructions; and at least one processor configured to execute the instructions to: acquire a road surface image in which a road surface is imaged; analyze a state of a crack on the road surface from the road surface image; calculate a probability of occurrence of a pothole, the probability being predicted from an analysis result, using a prediction model that has learned data showing a relationship between a state of a crack and an occurrence of a pothole as training data; and output information indicating the calculated probability of occurrence of the pothole.

### TECHNICAL FIELD

The present disclosure relates to a pothole prediction system and the like.

### BACKGROUND ART

Deterioration such as cracking occurs on a paved road due to factors such as traveling of a vehicle and rainfall. In order to grasp the deterioration state of the road and plan repair of the road, the deterioration state of the road is analyzed.

PTL 1 discloses a method of quantitatively analyzing a pothole occurrence possibility in a drainage pavement. In PTL 1, the pothole occurrence possibility is predicted using a local sinking amount calculated from road surface property data, a G/R value that is a ratio between green and red obtained from image data, and an average profile depth value calculated from road surface property data.

PTL 2 discloses a crack analysis device that detects a crack having a specific shape from an image in which a road surface is imaged and displays a crack detection result. PTL 3 discloses a deterioration prediction system that predicts a level of road deterioration at a future time point, and superimposes and displays the predicted deterioration level on a map in a display mode according to the deterioration level for each prediction time point.

### CITATION LIST

### Patent Literature

PTL 1: JP 2018-028486 A
PTL 2: JP 2018-040666 A
PTL 3: WO 2021/192790 A1

### SUMMARY OF INVENTION

### Technical Problem

According to PTL 1, a local sinking amount and an average profile depth are used to predict an occurrence possibility of a pothole. Therefore, it is not possible to predict the possibility of occurrence of a pothole without using a light cutting imaging device that emits a slit laser.

An object of the present disclosure is to provide a pothole prediction system and the like capable of obtaining a probability of occurrence of a pothole with a simple configuration.

### Solution to Problem

A pothole prediction system according to the present disclosure includes an acquisition means for acquiring a road surface image in which a road surface is imaged, an analysis means for analyzing a state of a crack on the road surface from the road surface image, a calculation means for calculating a probability of occurrence of a pothole, the probability being predicted from an analysis result by the analysis means, using a prediction model that has learned data showing a relationship between a state of a crack and an occurrence of a pothole as training data, and an output means for outputting information indicating the calculated probability of occurrence of the pothole.

A pothole prediction method according to the present disclosure includes acquiring a road surface image in which a road surface is imaged, analyzing a state of a crack on the road surface from the road surface image, calculating a probability of occurrence of a pothole, the probability being predicted from an analysis result, using a prediction model that has learned data showing a relationship between a state of a crack and an occurrence of a pothole as training data, and outputting information indicating the calculated probability of occurrence of the pothole.

A program according to the present disclosure causes a computer to execute the steps of acquiring a road surface image in which a road surface is imaged, analyzing a state of a crack on the road surface from the road surface image, calculating a probability of occurrence of a pothole, the probability being predicted from an analysis result, using a prediction model that has learned data showing a relationship between a state of a crack and an occurrence of a pothole as training data, and outputting information indicating the calculated probability of occurrence of the pothole. The program may be stored in a non-transitory computer-readable recording medium.

### Advantageous Effects of Invention

According to the present disclosure, the probability of occurrence of a pothole can be obtained with a simple configuration.

### BRIEF DESCRIPTION OF DRAWINGS

FIG. 1 is a diagram illustrating an outline of an apparatus connected to a pothole prediction system.

FIG. 2 is a block diagram illustrating a configuration example of a pothole prediction system according to the first example embodiment.

FIG. 3 is a diagram illustrating an example of a detection result of a crack.

FIG. 4 is a diagram illustrating an example of training data.

FIG. 5 is a diagram illustrating an example of a prediction model.

FIG. 6 is a flowchart illustrating an operation example of the pothole prediction system according to the first example embodiment.

FIG. 7 is a view illustrating a display mode of an icon.

FIG. 8 is a diagram illustrating an example of a screen to be displayed.

FIG. 9 is a flowchart illustrating an operation example of an output unit that displays a scale.

FIG. 10 is a block diagram illustrating a configuration example of a pothole prediction system according to the second example embodiment.

FIG. 11 is a flowchart illustrating an operation example of the pothole prediction system according to the second example embodiment.

FIG. 12 is a diagram illustrating an example of a screen to be displayed.

FIG. 13 is a diagram illustrating an example of a screen to be displayed.

FIG. 14 is a block diagram illustrating an example of a hardware configuration of a computer.

### EXAMPLE EMBODIMENT

The cracks of the road surface spread with linear cracks increasing, and eventually advance to a pothole where the pavement is peeled off and depressed. In order to prevent an accident due to the generated pothole, the manager of the road surface repairs the road surface. When there is information serving as a basis for planning the repair of the road surface, the plan can be efficiently created.

A pothole prediction system according to the present disclosure is a system that predicts a probability of occurrence of a pothole using a crack state on a road surface analyzed from a road surface image and a prediction model that has learned a relationship between the crack state and occurrence of the pothole.

The road surface targeted by the pothole prediction system is not limited to a general road on which vehicles and people pass, and includes a test course of a vehicle, a runway, a guide path, and the like of an airport. That is, the pothole prediction system can widely target a paved road surface.

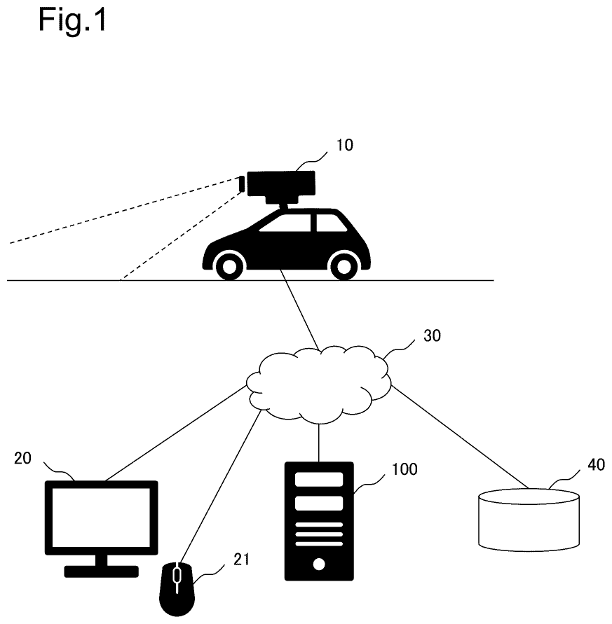

FIG. 1 is a diagram illustrating an outline of a device communicably connected to a pothole prediction system 100 in a wired or wireless manner via a communication network 30. The pothole prediction system 100 is connected to, for example, a camera 10, a display 20, an input device 21, and a database 40.

The camera 10 captures a road surface image including a road surface. The road surface image captured by the camera 10 is stored in the database 40. The camera 10 is achieved by, for example, a drive recorder mounted on a vehicle. However, the type of the camera is not limited thereto, and various types of cameras may be used. For example, the road surface image may be captured by a camera mounted on another moving body such as a bicycle or a drone, a camera carried by a person, or a fixed camera installed on a road. The road surface image may be a still image or a moving image continuously captured by the camera 10 while the moving body is moving. The road surface image may be captured by a person or may be automatically captured.

The display 20 displays information to the user. The display 20 includes, for example, a display, a tablet, and the like. The display 20 displays various pieces of information according to the output from the pothole prediction system 100. The information to be displayed will be described later.

The input device 21 receives an operation from a user. The input device 21 includes, for example, a mouse, a keyboard, and the like. In a case where the display 20 is a touch panel display, the display 20 may be configured as the input device 21.

The database 40 stores a map. The database 40 may further store the road surface image captured by the camera 10. The database 40 that stores the map and the database 40 that stores the road surface image may be provided separately.

### First Example Embodiment

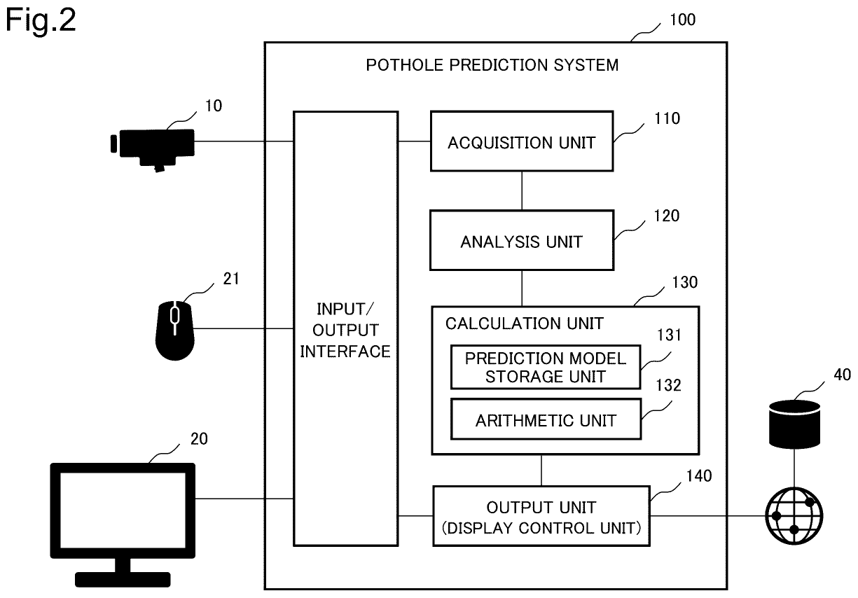

FIG. 2 is a block diagram illustrating a configuration example of the pothole prediction system 100 according to the first example embodiment. A pothole prediction system 100 according to the first example embodiment includes an acquisition unit 110, an analysis unit 120, a calculation unit 130, and an output unit 140. The calculation unit 130 includes a prediction model storage unit 131 and an arithmetic unit 132.

The acquisition unit 110 acquires a road surface image in which a road surface is imaged. For example, acquisition unit 110 acquires the road surface image from database 40. In another example, the acquisition unit 110 may acquire the road surface image from camera 10 via communication network 30. At this time, the pothole prediction system 100 is communicably connected to the camera 10 as necessary.

The acquisition unit 110 may acquire a road surface image and position information about a location where the road surface image is captured. The position information includes, for example, latitude and longitude, position information by a global navigation satellite system (GNSS) or a global positioning system (GPS), or a position on a map.

Further, the acquisition unit 110 may acquire the road surface image and a date and time when the road surface image is captured.

The analysis unit 120 analyzes a crack state from the road surface image acquired by the acquisition unit 110. For example, the analysis unit 120 detects a crack and analyzes a state of the detected crack.

For example, the analysis unit 120 detects a crack using a known image recognition technique for the road surface image. The analysis unit 120 may detect a crack using the trained model. The analysis unit 120 may determine whether the road surface is deteriorated for each pixel of the road surface image.

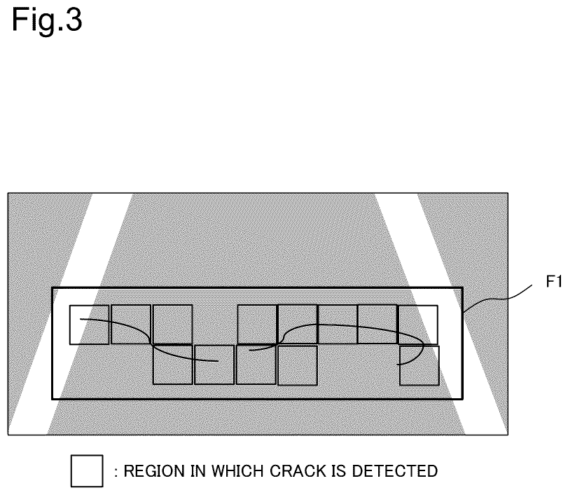

FIG. 3 is a diagram illustrating an example of a detection result of a crack on a road from a road surface image in which the road is imaged. The imaging range of the road surface image is not limited to the example of FIG. 3, and may be narrow or wide in the longitudinal direction or the lateral direction, for example. For example, the road surface image may include the sky and sidewalks and buildings on both sides of the road. For example, the analysis unit 120 may detect road surface deterioration included in a detection region F1 in the road surface image. Detection region F1 is a region whose road surface deterioration is to be detected.

For example, the analysis unit 120 divides the road surface image in a predetermined unit. The analysis unit 120 may detect and analyze cracks for each unit. The analysis unit 120 may divide the detection region F1 where the road surface deterioration is detected in the road surface image by a block having a predetermined size.

The state of the crack indicated by the analysis result by the analysis unit 120 is data indicating the progress state of the crack generated on the road surface. The state of the crack includes, for example, a crack rate, a crack length, a crack width, a crack area, a crack shape, and presence or absence of the crack.

The crack rate is represented by, for example, 100×(crack area/road surface area). The crack area is calculated by any method. Note that a method of calculating the crack rate is not particularly limited, and a known calculation method can be applied in addition to the above.

The crack width may be represented by the width of the widest crack in a predetermined range. The crack width may be represented by an average of the widths of the cracks in a predetermined range.

The crack shape includes, for example, whether the detected crack is a straight crack or a tortoise-shell crack. The crack shape may be represented by a numerical value related to the presence or absence of a crack of a predetermined shape. For example, a case where the road surface image includes a tortoise-shell crack may be represented as 1, and a case where the road surface image does not include a tortoise-shell crack may be represented as 0.

The crack state analyzed by the analysis unit 120 may include the tortoise-shell crack amount. The tortoise-shell crack amount indicates the amount of intersecting cracks. The tortoise-shell crack amount may be represented by the number of units including tortoise-shell cracks when the road surface image is divided in a predetermined unit. For example, when one road surface image is divided in a block, the tortoise-shell crack amount is represented by the number of tortoise-shell crack blocks, which is the number of blocks each including a crack constituting a tortoise-shell crack. The tortoise-shell crack amount may be the area of blocks including tortoise-shell cracks. Alternatively, the tortoise-shell crack amount may be represented by the area of cracks constituting the tortoise-shell cracks.

The calculation unit 130 calculates the probability of occurrence of a pothole, the probability being predicted from the analysis result by the analysis unit 120, using a prediction model learned data indicating the relationship between the state of a crack and the occurrence of a pothole as training data. The probability of occurrence of a pothole indicates the probability of occurrence of a pothole within a predetermined period. The predetermined period can be appropriately set, for example, one month, half a year, one year, or the like. The probability of occurrence is represented by a numerical value between 0 and 1. The higher the calculated probability of occurrence, the higher the probability that a pothole will occur on the road surface analyzed by the analysis unit 120. The occurrence probability may be expressed by a percentage between 0% and 100%.

The prediction model storage unit 131 included in the calculation unit 130 stores a trained prediction model. The arithmetic unit 132 included in the calculation unit 130 inputs the analysis result by the analysis unit 120 to the trained prediction model and calculates the probability of occurrence of a pothole.

The calculation unit 130 calculates the probability of occurrence of a pothole using, for example, logistic regression. The learning phase of the prediction model will be described. The prediction model in the logistic regression can be expressed by giving the value x obtained from the linear regression equation of Formula 1 to the sigmoid function of Formula 2.

$$x = explanatory variable 1 \times {w}_{1} + explanatory variable 2 \times {w}_{2} + ⋯ + explanatory variable z \times {w}_{z} \qquad [ Math . 1 ]$$

$$y = \frac{1}{1 + exp ( - x )} \qquad [ Math . 2 ]$$

Formula 1 is a linear regression equation in which each explanatory variable is multiplied by a weight. y in Formula 2 is an objective variable. The number of explanatory variables is not particularly limited. When there is at least one explanatory variable, prediction can be performed. By giving the value of x to the sigmoid function of Formula 2, an output value y between 0 and 1 is obtained. The weight learning is performed using the label of 0 or 1 attached to the explanatory variable of the training data. For example, when no pothole occurs, the label 0 is attached, and when a pothole occurs, the label 1 is attached. When the weight that minimizes the error between the output value y and the label is obtained, the learning of the prediction model ends.

As the crack of the road surface progresses, water such as rain easily permeates the inside of the road surface. Therefore, the pavement is deteriorated by water, and a pothole is likely to occur. Therefore, there is a relationship between the state of the crack and the occurrence of the pothole.

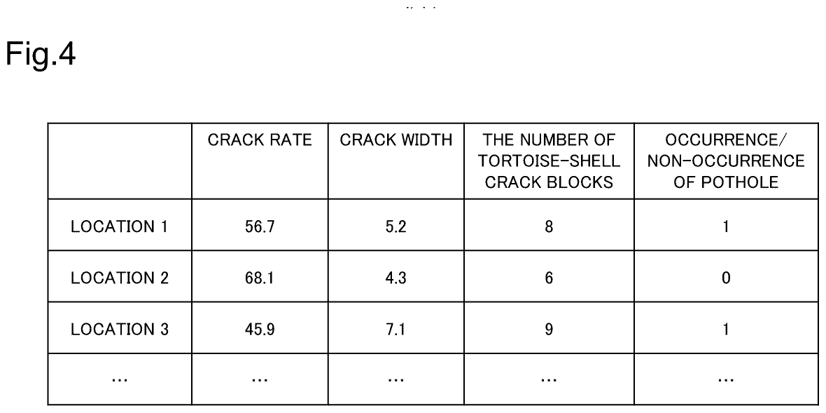

FIG. 4 is a diagram illustrating an example of training data indicating a relationship between a state of a crack and occurrence of a pothole. As explanatory variables, for example, values of a crack rate, a crack width, and the number of tortoise-shell crack blocks at a plurality of locations may be used. The training data of FIG. 4 includes a label indicating whether a pothole has occurred at each location.

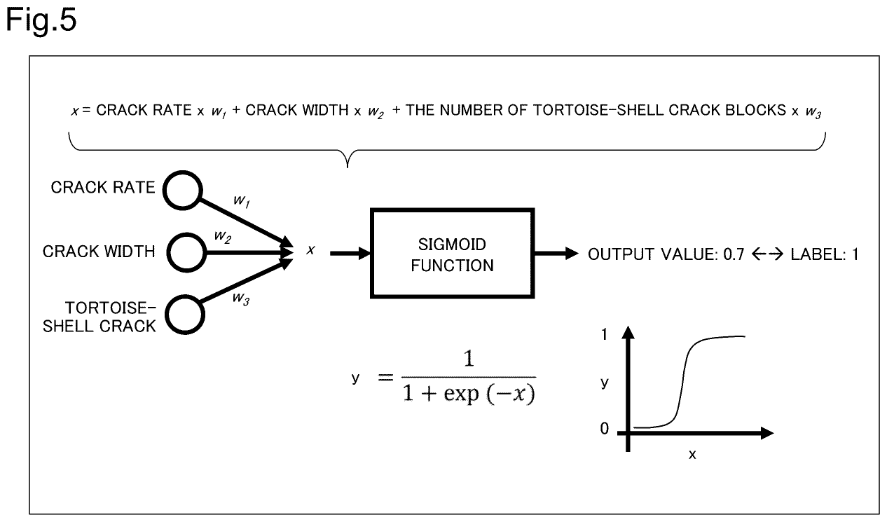

The prediction model in the case of using the training data of FIG. 4 will be described with reference to FIG. 5. When the training data of FIG. 4 is used, the formula of Formula 1 can be expressed as the following Formula 3.

$$x = crack rate \times {w}_{1} + crack width \times {w}_{2} + number of tortoise - shell crack blocks \times {w}_{3} \qquad [ Math . 3 ]$$

For example, the value of x is obtained by giving the values of the crack rate 56.7, the crack width 5.2, and the number of tortoise-shell crack blocks 8 at the location 1 to Formula 3. By giving the obtained value of x to the sigmoid function of Formula 2, an output value y such as 0.7 is obtained. Since the label is 1 at the location 1, the weights w₁, w₂, and w₃ are adjusted in such a way that the output value y approaches 1. Similarly, the weights w₁, w₂, and w₃ are adjusted using the values of the crack rate, the crack width, and the number of tortoise-shell crack blocks at each of the location 2, the location 3, and the like. Therefore, weights w₁, w₂, and w₃ with which the accurate probability of occurrence of a pothole can be predicted are learned from the crack rate, the crack width, and the number of tortoise-shell crack blocks observed at various locations.

The above-described training of the prediction model may be performed in the calculation unit 130 or may be performed in another device (not illustrated).

The prediction model storage unit 131 stores the prediction model trained in this way. In the phase of inference based on the prediction model, the arithmetic unit 132 inputs an analysis result by the analysis unit 120 as an explanatory variable to the prediction model stored in the prediction model storage unit 131. The arithmetic unit 132 outputs a calculation result of the probability of occurrence of a pothole for the input explanatory variable.

For example, in the case of using the prediction model illustrated in FIG. 5, the analysis unit 120 analyzes a state of a crack on the road surface from the road surface image to output a crack rate, a crack width, and the number of tortoise-shell crack blocks as an analysis result. The arithmetic unit 132 obtains the value of x in Formula 3 from the value of the analysis result acquired from the analysis unit 120. The arithmetic unit 132 obtains the predicted value y of the occurrence probability by giving the value of x to the sigmoid function of Formula 2.

According to the above example, the crack rate, the crack width, and the number of tortoise-shell crack blocks are used as explanatory variables. However, the type of the explanatory variable can be appropriately selected. For example, an explanatory variable including at least one of a crack rate, a crack length, a crack width, a crack area, a crack shape, a tortoise-shell crack amount, and presence or absence of a crack may be used as the explanatory variable. When the accuracy of the value predicted using one explanatory variable is insufficient, two or more explanatory variables may be used. Even when it is difficult to predict the probability of occurrence of a pothole from one explanatory variable such as a crack rate, it is possible to predict the probability of occurrence of a pothole by combining a plurality of explanatory variables indicating a state of a crack.

The training data may be data including road information as an explanatory variable in addition to the state of the crack. The calculation unit 130 may calculate the probability of occurrence of the pothole based on the analysis result by the analysis unit 120 and the road information of the road surface using the prediction model. The road information is information indicating a feature of a road on which vehicles pass. The road information includes, for example, a traffic volume, a width of a lane, or the number of lanes. The traffic volume represents, for example, the amount of vehicles passing on the road surface within a predetermined period. The traffic volume may be an amount of vehicles each with a weight equal to more than a predetermined weight. The larger the traffic volume, the faster the deterioration speed of the road surface. As the lane width is narrower, a load is more likely to be applied to the same position on the road surface, and deterioration is more likely to occur. The smaller the number of lanes is, the more traffic volume is concentrated and the more likely the road is to deteriorate. Therefore, the probability of occurrence of a pothole is predicted to be higher as the traffic volume is higher, the width of the lane is narrower, or the number of lanes is smaller.

The case where the probability of occurrence of a pothole is calculated using logistic regression is described above. However, the calculation unit 130 may calculate the probability of occurrence of the pothole using another prediction model that predicts the probability of occurrence of the event. For example, the calculation unit 130 may use a Light Gradient Boosting Machine (GBM).

The calculation unit 130 may further predict the size of the generated pothole. At this time, the prediction model storage unit 131 may store a trained model for predicting the size of the pothole based on the state of the crack. The arithmetic unit 132 predicts the size of the pothole based on the state of the crack analyzed by the analysis unit 120 and the trained model. The state of the crack serving as an explanatory variable is, for example, a crack rate, a crack length, or a tortoise-shell crack amount. The size of the pothole serving as the objective variable is represented by, for example, any of an area, a width, a length, and a depth of the pothole, or a combination thereof.

The output unit 140 outputs information indicating the probability of occurrence of a pothole calculated by the calculation unit 130. The output unit 140 may be a display control unit that controls display on the display 20. The output unit 140 may display a numerical value of occurrence probability of the pothole, for example, on the display 20.

The output unit 140 may display the occurrence time of the pothole estimated according to the probability of occurrence of the pothole. The output unit 140 displays, for example, a period of one month or less, three months or less, or one year or less as the occurrence time of the pothole. The correspondence between the probability of occurrence of a pothole and the estimated occurrence time of a pothole may be determined in advance. For example, a location at which the probability of occurrence of a pothole is calculated to be 80% is estimated to have a pothole within one month, and a location at which the probability of occurrence of a pothole is calculated to be 60% to 70% is estimated to have a pothole within 2 to 3 months. In this way, the output unit 140 displays the occurrence time of the pothole based on the predetermined correspondence relationship.

The output unit 140 may display an icon indicating the calculated probability of occurrence of the pothole on a map indicating the road surface whose image used to predict the probability of occurrence of the pothole is captured. For example, the output unit 140 acquires map data from the database 40. The output unit 140 acquires, for example, position information of a location where the road surface image is captured from the acquisition unit 110. The output unit 140 displays an icon indicating the probability of occurrence of a pothole on the map as information indicating the probability of occurrence of the pothole.

The output unit 140 may display an icon at a location on the map where the value of the calculated probability of occurrence of a pothole is equal to more than a predetermined value. The threshold value for displaying the icon may be changeable by the user. For example, the user inputs, via the input device 21, a value that is a threshold value for whether to display an icon. At this time, the pothole prediction system 100 may further include a reception unit (not illustrated) that receives a threshold value of the probability of occurrence of a pothole. The output unit 140 displays an icon indicating a probability of occurrence of a pothole, the probability being equal to more than the threshold value received by the reception unit, on the map.

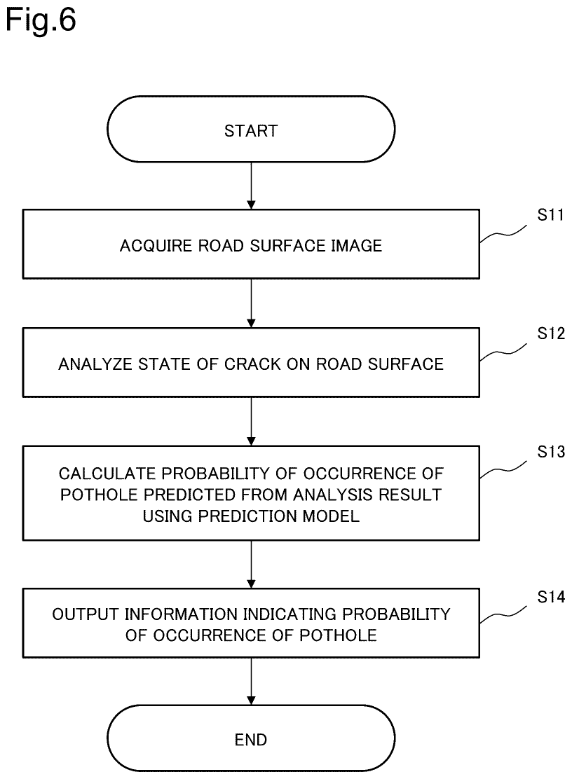

FIG. 6 is a flowchart illustrating an operation example of the pothole prediction system 100. The pothole prediction system 100 may start the operation of FIG. 6 in response to an operation by the user using the input device 21.

The acquisition unit 110 acquires the road surface image in which the road surface is imaged (step S11). The acquisition unit 110 provides the acquired image to the analysis unit 120.

The analysis unit 120 analyzes a state of a crack on the road surface from the road surface image acquired by the acquisition unit 110 (step S12). The analysis unit 120 provides the analyzed crack state to the calculation unit 130.

The calculation unit 130 calculates the probability of occurrence of a pothole, the probability being predicted from the analysis result by the analysis unit 120, using a prediction model learned data indicating the relationship between the state of a crack and the occurrence of a pothole as training data (step S13). The calculation unit 130 provides the calculated pothole occurrence probability to the output unit 140.

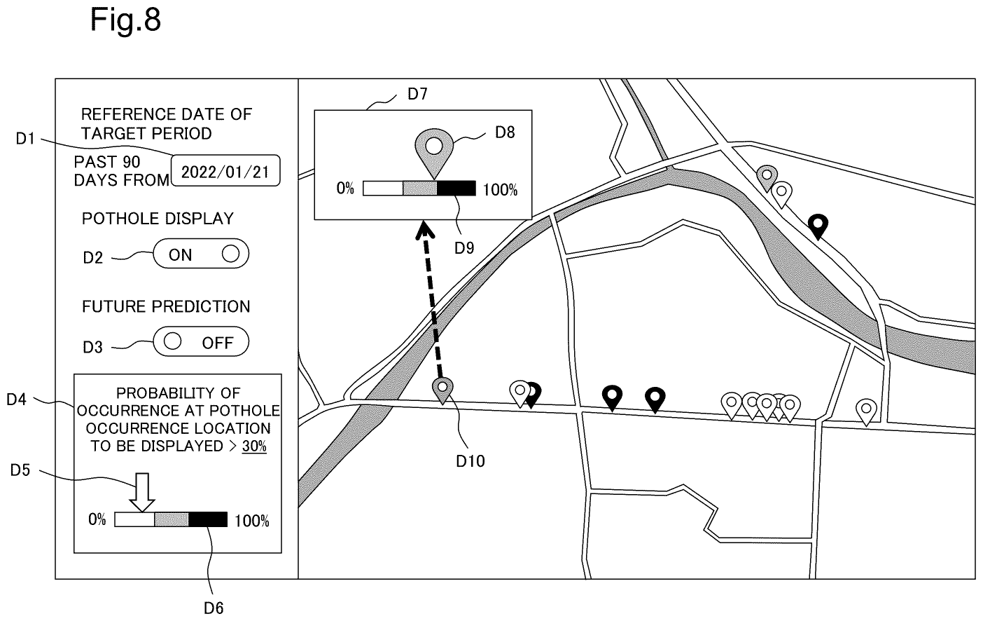

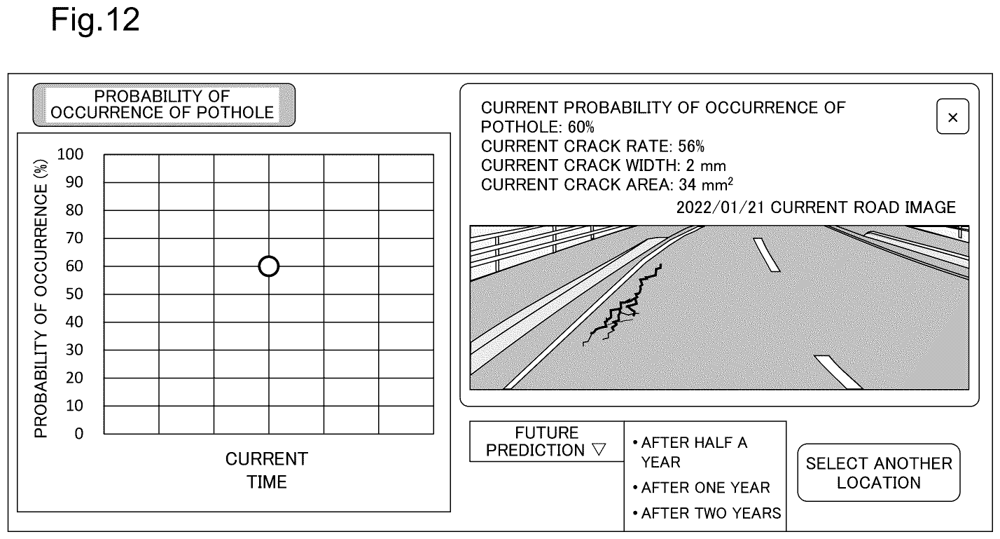

The output unit 140 outputs information indicating the probability of occurrence of a pothole calculated by the calculation unit 130 (step S14). For example, as illustrated in FIG. 12 to be described later, the output unit 140 outputs the numerical value of the probability of occurrence of the pothole to the display 20. Alternatively, as illustrated in FIG. 8 to be described later, the output unit 140 displays an icon at a location on the map where the probability of occurrence of a pothole is equal to more than 30%, for example, as processing of outputting information indicating the probability of occurrence of a pothole.

Thus, the pothole prediction system 100 ends the operation of FIG. 6.

A mode in which the output unit 140 displays information indicating the probability of occurrence of a pothole on the display 20 will be described in more detail.

The output unit 140 may change the color of the icon on the map according to the probability of occurrence of the pothole. For example, the icon may be displayed with the probability of occurrence of 0% to 39% in blue, the probability of occurrence of 40% to 69% in yellow, and the probability of occurrence of equal to more than 70% in red. The type of color and the stage of color change can be appropriately designed.

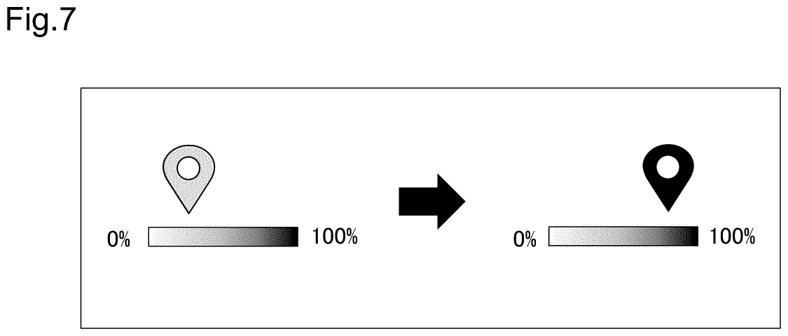

FIG. 7 is a diagram illustrating a display mode of icons according to the probability of occurrence of a pothole. For example, a map pin as illustrated in FIG. 7 can be used as an icon indicating a location where the probability of occurrence of a pothole is predicted. However, the shape of the icon is not limited to the map pin. For example, related to the color of the color scale bar illustrated in FIG. 7, the icon may be displayed in a lighter color as the occurrence probability is lower, and may be displayed in a darker color as the occurrence probability is higher.

FIG. 8 is a diagram illustrating an example of a screen displayed by the output unit 140. The screen of FIG. 8 includes an operation menu on the left side, and a map is displayed right of the operation menu. The operation menu includes a display D1 of the target period, a switching button D2 of the pothole display, and a switching button D3 of the future prediction function. The future prediction function will be described in the second example embodiment.

The target period indicates a period in which a plurality of road surface images used for analysis are captured. For example, the target period indicates that the imaging date of the road surface image is within the past 90 days from the reference date input to the screen.

When the user turns on the pothole display switching button D2, the output unit 140 displays an icon indicating the probability of occurrence calculated by the calculation unit 130 on the map. In FIG. 8, the probability of occurrence of a pothole is displayed on a map by icons of three colors. The output unit 140 may display icons only for some regions in the map. For example, the output unit 140 may display an icon for a region selected by the user on the map.

The operation menu in FIG. 8 further includes a user interface D4 for performing an operation of narrowing down icons to be displayed. In FIG. 8, the location where the icon is displayed is narrowed down to a location where the probability of occurrence of the pothole is “equal to more than 30%”. The user can appropriately set, via the input device 21, a value that is a threshold value for whether to display an icon. For example, the user may input the threshold value as a numerical value. The user may set the threshold value by moving an arrow D5 indicating the value of a scale D6 in FIG. 8 to the left and right. By the user setting the threshold value in this manner, the user can immediately check a location where the probability of occurrence of a pothole is high.

Further, when receiving the selection of the icon on the map, the output unit 140 may display a figure representing the probability of occurrence of the pothole indicated by the selected icon. For example, the output unit 140 displays a figure representing a reference indicating the magnitude of the probability of occurrence of a pothole as a figure representing the probability of occurrence of a pothole. The figure representing the reference of the probability of occurrence of a pothole is also referred to as a scale. Reference values (for example, 0% and 100%) of the probability of occurrence of a pothole are set to reference points of the scale (for example, both ends of the scale).

For example, the output unit 140 may display the scale on the map in such a way that an icon on the map indicates a value on the scale. An icon on the map indicates a value on the scale, so that the scale represents a value of a probability of occurrence of a pothole.

The scale displayed by the output unit 140 may be a color scale legend representing the probability of occurrence of a pothole indicated by the color of an icon on the map. The output unit 140 may display the color scale legend at a position where the color of the icon on the map matches the color on the scale.

The output unit 140 may display a scale indicating a value on the scale by an icon displayed separately from the selected icon on the map. As illustrated in FIG. 8, the output unit 140 may pop up a scale D9 and an icon D8 indicating a value on the scale on the map for a selected icon D10. In a pop-up region D7, for example, the icon D8 having the same color as the selected icon D10 indicates a value on the scale D9. In a case where the output unit 140 displays an icon indicating a value on the scale separately from the icon on the map, the icon indicating the value on the scale may be a figure different from the icon on the map, such as an arrow or a line.

In a case where the probability of occurrence of the pothole is displayed in colors with a small number of stages, the output unit 140 displays the scale in association with the icon, so that the user can grasp the predicted occurrence probability in more detail than the icon on the map. Even in a case where the probability of occurrence of a pothole is displayed in colors with a multiple number of stages, the output unit 140 displays the scale, so that the user can check the occurrence probability indicated by the color of the icon on the scale.

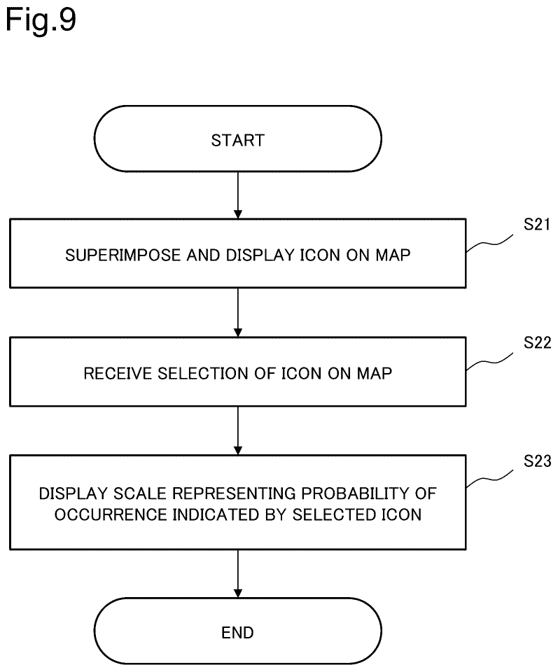

FIG. 9 is a flowchart illustrating an operation example of the output unit 140 that displays the scale. For example, after step S13 in FIG. 6, the output unit 140 that has received the probability of occurrence of a pothole starts the operation in FIG. 9.

The output unit 140 superimposes and displays an icon indicating the probability of occurrence of the pothole on the map (step S21). Thereafter, the output unit 140 receives selection of an icon on the map selected by the user using the input device 21 (step S22).

The output unit 140 displays the scale by associating the occurrence probability indicated by the selected icon with the position of the occurrence probability on the scale (step S23). Thus, the output unit 140 ends the operation of FIG. 9.

The output unit 140 may display the probability of occurrence of a pothole on the map by a method other than use of icons. For example, the output unit 140 displays a region on the map divided in a mesh shape or a region of the road divided for each predetermined section in a color related to the probability of occurrence of a pothole in the region.

The output unit 140 may further display the degradation degree of the road surface for each road surface section in addition to the probability of occurrence of the pothole on the map. For example, the output unit 140 may display an icon such as an arrow with a different color according to the deterioration degree for each road surface section.

The output unit 140 may display an outline of the information indicating the probability of occurrence at the plurality of locations and display more detailed information for the selected location. The output unit 140 may further display, as the detailed information, the road surface image of the location, the imaging date and time of the road surface image, the analysis result of the state of the crack, and the value of the calculated probability of occurrence of the pothole. The output unit 140 displays, for example, the road surface image used for analysis by the analysis unit 120. Since the road surface image and the probability of occurrence of the pothole are displayed side by side, the user can easily grasp the degree of the crack indicated by the numerical value of the probability of occurrence of the pothole. The output unit 140 displays, for example, the imaging date and time acquired by the acquisition unit 110. When the calculation unit 130 predicts the size of the generated pothole, the output unit 140 may further display the predicted size of the pothole.

The analysis unit 120 according to the first example embodiment analyzes a state of a crack on the road surface from the road surface image. The calculation unit 130 calculates the probability of occurrence of a pothole, the probability being predicted from the analysis result, using a prediction model learned data indicating the relationship between the state of a crack and the occurrence of a pothole as training data. Therefore, according to the first example embodiment, the probability of occurrence of a pothole can be obtained with a simple configuration.

For example, according to the first example embodiment, the probability of occurrence of a pothole can be obtained based on crack information analyzed from a road surface image captured by a drive recorder. Therefore, it is not necessary to measure the local sinking amount or the average profile depth using the slit laser. Therefore, the probability of occurrence of a pothole can be obtained with a simple configuration.

According to the first example embodiment, occurrence of a pothole is predicted based on information about a crack that is one of main factors of occurrence of a pothole, whereby occurrence of a pothole can be predicted with high accuracy.

Further, according to the first example embodiment, since the output unit 140 outputs the information indicating the calculated probability of occurrence of the pothole, the user can efficiently consider the repair plan of the road surface according to the output information.

### Second Example Embodiment

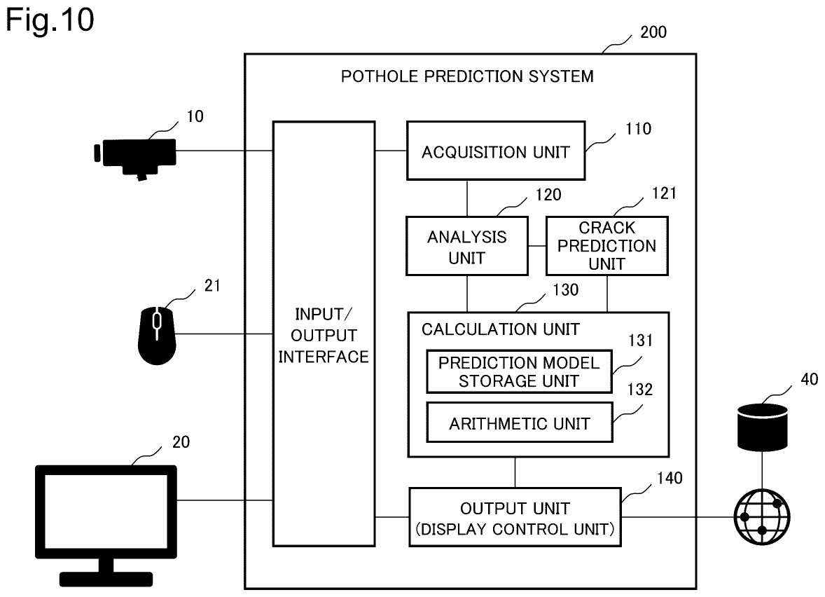

FIG. 10 is a block diagram illustrating a configuration of a pothole prediction system 200 according to the second example embodiment. The pothole prediction system 200 is different from the pothole prediction system 100 according to the first example embodiment in that it includes a crack prediction unit 121. Regarding the configuration of the second example embodiment, description of the configuration same as that of the first example embodiment will be partially omitted.

The crack prediction unit 121 predicts a future crack state of the road surface whose road surface image is captured based on the analysis result by the analysis unit 120. The crack prediction unit 121 predicts a state of a crack after a lapse of a predetermined period from a time point at which the road surface image was captured. The predetermined period is appropriately set to, for example, half a year, one year, or two years. The crack prediction unit 121 may predict the state of the crack at a future time point designated by the user. The crack prediction unit 121 may predict the state of a crack at a plurality of future time points.

A method of predicting a future crack state is not particularly limited. The crack prediction unit 121 may predict a future crack state using an existing technology. The crack prediction unit 121 predicts a crack rate, a crack width, a crack area, or a tortoise-shell crack amount in the future based on, for example, the crack rate, the crack width, the crack area, or the tortoise-shell crack amount analyzed by the analysis unit 120. The crack prediction unit 121 may predict a future crack state based on other information such as road information of a road surface and weather information in addition to the analysis result by the analysis unit 120.

For example, the calculation unit 130 calculates the probability of occurrence of a pothole, the probability being predicted from the prediction result by the crack prediction unit 121, using the prediction model same as the prediction model according to the first example embodiment.

The output unit 140 outputs information indicating the calculated probability of occurrence of the pothole. For example, the output unit 140 may display, on the display 20, a numerical value of the probability of occurrence of the pothole calculated based on a future crack state. The output unit 140 may display an icon indicating the calculated probability of occurrence of a pothole on the map. For example, in FIG. 8, when the switching button D3 of the future prediction function is pressed, the output unit 140 displays an icon indicating the probability of occurrence of a pothole based on the future crack state. The output unit 140 may further display the future crack state predicted by the crack prediction unit 121 for the selected location.

The output unit 140 may display a graph representing a time change in the probability of occurrence of a pothole. At this time, the pothole prediction system 200 may include a graph generation unit (not illustrated). The graph generation unit acquires and plots the probability of occurrence of the pothole calculated by the output unit 140. Then, the graph generation unit provides the generated graph to the output unit 140.

The output unit 140 may display a predicted image representing a future crack state. At this time, the pothole prediction system 200 may include an image generation unit (not illustrated). The image generation unit generates a predicted image in which the crack progresses, using the road surface image acquired by the acquisition unit 110. The image generation unit generates a predicted image in accordance with a future crack state predicted by the crack prediction unit 121, for example.

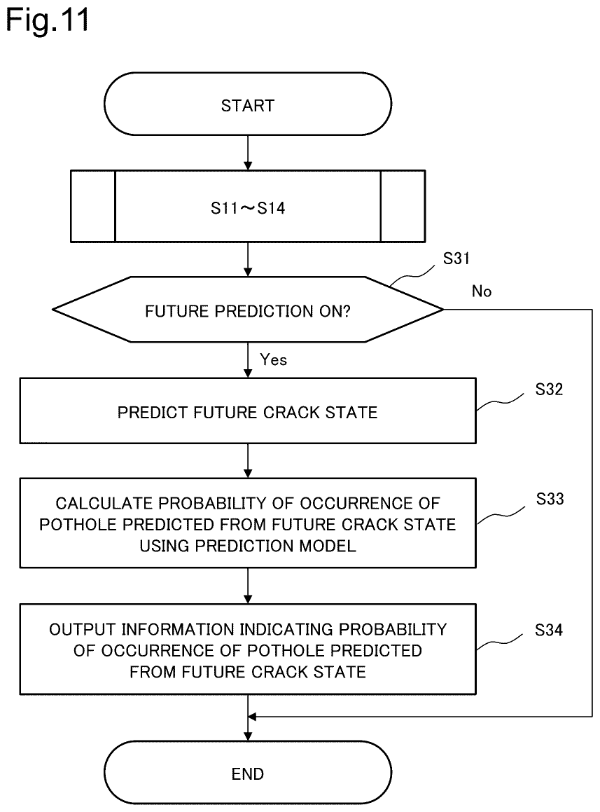

FIG. 11 is a flowchart illustrating an operation example of the pothole prediction system 200 according to the second example embodiment. For example, the pothole prediction system 200 performs the operations of steps S11 to S14 illustrated in FIG. 6.

After step S14, when the user turns on the switching button D3 of the future prediction function (step S31: Yes), the crack prediction unit 121 predicts a future crack state of the road surface whose road surface image is captured based on the analysis result by the analysis unit 120 (step S32). The crack prediction unit 121 provides a prediction result to the calculation unit 130.

The calculation unit 130 calculates the probability of occurrence of a pothole, the probability being predicted from the prediction result by the crack prediction unit 121, using the prediction model (step S33). The calculation unit 130 outputs the calculated probability of occurrence of the pothole to the output unit 140.

The output unit 140 outputs information indicating a probability of occurrence of a pothole, the probability being predicted from a future crack state (step S34). For example, the output unit 140 displays information indicating the probability of occurrence of a pothole on the display 20.

Thus, the pothole prediction system 200 ends the operation of FIG. 11.

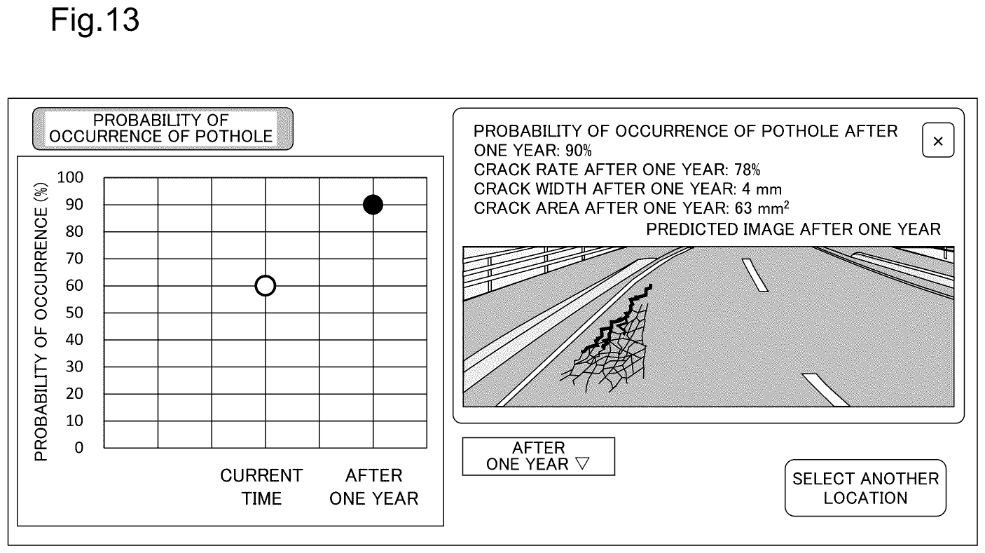

FIGS. 12 and 13 are diagrams illustrating examples of screens displayed by the output unit 140. FIG. 12 is a screen displaying information based on the captured road surface image. FIG. 13 is a screen displaying information based on a future crack state. The screen of FIG. 12 is displayed, for example, when the user selects a predetermined location on the map. When “one year later” is selected from the pull-down list displayed by pressing the “future prediction” button in FIG. 12, the screen in FIG. 13 is displayed.

On the screen of FIG. 12, the value of the probability of occurrence of a pothole calculated from the analysis result by the analysis unit 120 is displayed as the current probability of occurrence of a pothole. The screen of FIG. 12 includes an analysis result of the analysis unit 120, an analyzed road surface image showing the road surface, and a graph plotting a current probability of occurrence of a pothole. In another example, the output unit 140 may further plot the probability of occurrence of the pothole calculated based on the past road surface image.

On the screen of FIG. 13, the value of the probability of occurrence of a pothole calculated from the future crack state predicted by the crack prediction unit 121 is displayed as the probability of occurrence of a pothole after one year. The screen of FIG. 13 includes a future crack state predicted by the crack prediction unit 121 and a predicted image after one year. Further, the screen of FIG. 13 includes a graph in which the current probability of occurrence of a pothole and the probability of occurrence of a pothole after one year are plotted.

According to the second example embodiment, the crack prediction unit 121 predicts a future crack state on the road surface, and the calculation unit 130 calculates a probability of occurrence of a pothole, the probability being predicted from a prediction result by the crack prediction unit 121. Therefore, according to the second example embodiment, the probability of occurrence of a pothole based on the future crack state can be obtained. Therefore, the user can consider the necessity of longer term repair in consideration of the future progress of the crack. For example, the user can make a current repair plan based on the output according to the first example embodiment and make a next plan based on the output according to the second example embodiment.

According to the second example embodiment, the output unit 140 outputs the probability of occurrence of a pothole based on the crack state analyzed from the road surface image and the probability of occurrence of a pothole based on the future crack state. Therefore, the user can plan the repair of the road surface in consideration of the degree of increase in the probability of occurrence of the pothole.

The description of each example embodiment ends.

### [Modifications]

Each example embodiment may be modified and used.

For example, the pothole prediction system 100 may further include a repair location determination unit. For example, the repair location determination unit determines a location where the probability of occurrence of a pothole exceeds a predetermined threshold value as a location where repair is necessary. The repair location determination unit may determine a region where the number of locations where the probability of occurrence of a pothole exceeds a predetermined threshold value exceeds a predetermined threshold value as a region requiring repair. The output unit 140 outputs information indicating the determined location.

For example, the repair location determination unit acquires a repair plan including a location determined in advance as a location to be repaired. The repair location determination unit determines a location that is not included in the repair plan even though the probability of occurrence of a pothole exceeds a predetermined threshold value. As a result, the user can consider repair of a location not included in the repair plan.

The pothole prediction system 100 may further include a repair priority determination unit. The repair priority determination unit determines the repair priority of the road surface based on the probability of occurrence of the pothole calculated by the calculation unit 130 and other parameters. The output unit 140 displays a location having a high repair priority on the map.

The repair priority determination unit determines that a location where the probability of occurrence of a pothole exceeds a predetermined threshold value has a high priority. The repair priority determination unit may further determine the repair priority of the road surface based on the traffic volume of the road surface as another parameter. For example, when there are locations at which probability of occurrence of the pothole are the same, the repair priority determination unit may determine that a location with a higher traffic volume has a higher repair priority.

As another parameter, the repair priority determination unit may determine the repair priority based on an analysis result of a state of a crack, information about a width of a road, or the presence or absence of a bypass.

### [Hardware Configuration]

In each of the above-described example embodiments, each component of the pothole prediction system 100, 200 represents a block of functional units. Some or all of the components of the pothole prediction system 100, 200 may be achieved by an any combination of the computer 500 and a program.

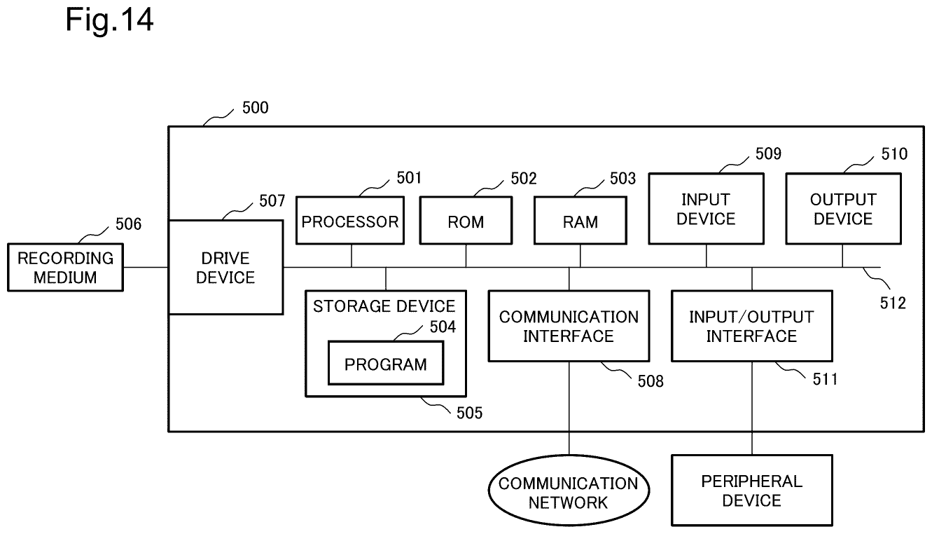

FIG. 14 is a block diagram illustrating an example of a hardware configuration of the computer 500. Referring to FIG. 14, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for implementing each function of the pothole prediction system 100, 200. The program 504 is stored in advance in the ROM 502, the RAM 503, and the storage device 505. The processor 501 implements each function of the pothole prediction system 100, 200 by executing instructions included in the program 504. The RAM 503 may store data to be processed by each function of the pothole prediction system 100, 200. For example, the road surface image may be stored in the RAM 503 of the computer 500.

The drive device 507 reads and writes the recording medium 506. The communication interface 508 provides an interface with a communication network. The input device 509 is, for example, a mouse, a keyboard, or the like, and receives an input of information from a user or the like. The output device 510 is, for example, a display, to output (displays) information to a user or the like. The input/output interface 511 provides an interface with a peripheral device. The bus 512 connects the components of the hardware. The program 504 may be supplied to the processor 501 via a communication network, or may be stored in the recording medium 506 in advance, read by the drive device 507, and supplied to the processor 501.

The hardware configuration illustrated in FIG. 14 is an example, and other components may be added or some components may not be included.

There are various modifications of the method of achieving the pothole prediction system 100, 200. For example, the pothole prediction system 100, 200 may be achieved by any combinations of a computer and a program different for each component. A plurality of components included in the pothole prediction system 100, 200 may be achieved by any combinations of one computer and a program.

At least part of the pothole prediction system 100, 200 may be provided in a software as a service (SaaS) format. That is, at least part of the functions for implementing the pothole prediction system 100, 200 may be executed by software executed via a network.

While the present disclosure has been particularly illustrated and described with reference to example embodiments thereof, the present disclosure is not limited to these example embodiments. Various modifications that can be understood by those of ordinary skill in the art can be made to the configuration and details of the present disclosure within the scope of the present disclosure. The configurations in the respective example embodiments can be combined with each other without departing from the scope of the present disclosure.

Some or all of the above example embodiments may be described as the following Supplementary Notes, but are not limited to the following.

### [Supplementary Note 1]

A pothole prediction system including
an acquisition means for acquiring a road surface image in which a road surface is imaged,
an analysis means for analyzing a state of a crack on the road surface from the road surface image,
a calculation means for calculating a probability of occurrence of a pothole, the probability being predicted from an analysis result by the analysis means, using a prediction model that has learned data showing a relationship between a state of a crack and an occurrence of a pothole as training data, and
an output means for outputting information indicating the calculated probability of occurrence of the pothole.

### [Supplementary Note 2]

The pothole prediction system according to Supplementary Note 1, wherein
the analysis result includes at least one of a crack rate, a crack length, a crack width, a crack area, a crack shape, a tortoise-shell crack amount, and presence or absence of a crack.

### [Supplementary Note 3]

The pothole prediction system according to Supplementary Note 2, wherein
the analysis result includes a crack rate, a crack width, and a tortoise-shell crack amount.

### [Supplementary Note 4]

The pothole prediction system according to Supplementary Note 3, wherein
when the road surface image is divided in a predetermined unit, the tortoise-shell crack amount is the number of the units each including a tortoise-shell crack.

### [Supplementary Note 5]

The pothole prediction system according to any one of Supplementary Notes 1 to 4, further including
a crack prediction means for predicting a future crack state of the road surface based on the analysis result, wherein
the calculation means calculates a probability of occurrence of a pothole, the probability being predicted from a prediction result by the crack prediction means.

### [Supplementary Note 6]

The pothole prediction system according to any one of Supplementary Notes 1 to 5, wherein
the output means displays an icon indicating the calculated probability of occurrence of the pothole on a map indicating the road surface.

### [Supplementary Note 7]

The pothole prediction system according to Supplementary Note 6, wherein
when receiving selection of the icon on the map, the output means displays a figure representing a reference of a probability of occurrence of the pothole indicated by the selected icon.

### [Supplementary Note 8]

The pothole prediction system according to Supplementary Note 6 or 7, further including
a reception means for receiving a threshold value of a probability of occurrence of the pothole, wherein
the output means displays the icon indicating a probability of occurrence of the pothole, the probability being equal to more than the received threshold value.

### [Supplementary Note 9]

The pothole prediction system according to any one of Supplementary Notes 1 to 8, wherein
the training data is data includes road information as an explanatory variable in addition to a state of a crack, and
the calculation means calculates a probability of occurrence of the pothole based on the analysis result and the road information of the road surface.

### [Supplementary Note 10]

A pothole prediction method including
acquiring a road surface image in which a road surface is imaged,
analyzing a state of a crack on the road surface from the road surface image,
calculating a probability of occurrence of a pothole, the probability being predicted from an analysis result, using a prediction model that has learned data showing a relationship between a state of a crack and an occurrence of a pothole as training data, and
outputting information indicating the calculated probability of occurrence of the pothole.

### [Supplementary Note 11]

A recording medium that non-transiently records a program for causing a computer to execute the steps of
acquiring a road surface image in which a road surface is imaged,
analyzing a state of a crack on the road surface from the road surface image,
calculating a probability of occurrence of a pothole, the probability being predicted from an analysis result, using a prediction model that has learned data showing a relationship between a state of a crack and an occurrence of a pothole as training data, and
outputting information indicating the calculated probability of occurrence of the pothole.

### REFERENCE SIGNS LIST

100 pothole prediction system
110 acquisition unit
120 analysis unit
130 calculation unit
131 prediction model storage unit
132 arithmetic unit
140 output unit
10 camera
20 display
21 input device
30 communication network
40 database

What is claimed is:

1. A pothole prediction system comprising:
at least one memory storing instructions; and
at least one processor configured to execute the instructions to:
acquire a road surface image in which a road surface is imaged;
analyze a state of a crack on the road surface from the road surface image;
calculate a probability of occurrence of a pothole, the probability being predicted from an analysis result, using a prediction model that has learned data showing a relationship between a state of a crack and an occurrence of a pothole as training data; and
output information indicating the calculated probability of occurrence of the pothole.

2. The pothole prediction system according to claim 1, wherein
the analysis result includes at least one of a crack rate, a crack length, a crack width, a crack area, a crack shape, a tortoise-shell crack amount, and presence or absence of a crack.

3. The pothole prediction system according to claim 2, wherein
the analysis result includes the crack rate, the crack width, and the tortoise-shell crack amount.

4. The pothole prediction system according to claim 3, wherein
when the road surface image is divided in a predetermined unit, the tortoise-shell crack amount is the number of the units each including a tortoise-shell crack.

5. The pothole prediction system according to claim 1, wherein the at least one processor is further configured to execute the instructions to:
predict a future crack state of the road surface based on the analysis result, wherein
calculate the probability of occurrence of a pothole, the probability being predicted from a prediction result.

6. The pothole prediction system according to claim 1, wherein the at least one processor is further configured to execute the instructions to:
display an icon indicating the calculated probability of occurrence of the pothole on a map indicating the road surface.

7. The pothole prediction system according to claim 6, wherein the at least one processor is further configured to execute the instructions to:
when receiving selection of the icon on the map, display a figure representing a reference of a probability of occurrence of the pothole indicated by the selected icon.

8. The pothole prediction system according to claim 6 wherein the at least one processor is further configured to execute the instructions to:
receive a threshold value of the probability of occurrence of the pothole; and
display the icon indicating the probability of occurrence of the pothole, the probability being equal to more than the received threshold value.

9. The pothole prediction system according to claim 1, wherein
the training data is data including road information as an explanatory variable in addition to the state of a crack, and the at least one processor is further configured to execute the instructions to:
calculate the probability of occurrence of the pothole based on the analysis result and the road information of the road surface.

10. A pothole prediction method comprising:
acquiring a road surface image in which a road surface is imaged;
analyzing a state of a crack on the road surface from the road surface image;
calculating a probability of occurrence of a pothole, the probability being predicted from an analysis result, using a prediction model that has learned data showing a relationship between a state of a crack and an occurrence of a pothole as training data; and
outputting information indicating the calculated probability of occurrence of the pothole.

11. A non-transient recording medium that records a program for causing a computer to execute the steps of:
acquiring a road surface image in which a road surface is imaged;
analyzing a state of a crack on the road surface from the road surface image;
calculating a probability of occurrence of a pothole, the probability being predicted from an analysis result, using a prediction model that has learned data showing a relationship between a state of a crack and an occurrence of a pothole as training data; and
outputting information indicating the calculated probability of occurrence of the pothole.
